(19) United States
(12) Patent Application Publication
(10) Pub. No.: US 2025/0299259 A1
(43) Pub. Date: Sep. 25, 2025

(54) METHOD FOR IMPROVING THE FINANCIAL PERFORMANCE OF PRIVATE FUND INVESTMENTS

(71) Applicant: Sageworth Holdings, LLC, Lancaster, PA (US)

(72) Inventors: Erik Casalinuovo, Malvern, PA (US); Reed Dame, Lancaster, PA (US)

(73) Assignee: Sageworth Holdings, LLC, Lancaster, PA (US)

(21) Appl. No.: 19/084,115

(22) Filed: Mar. 19, 2025

Related U.S. Application Data
(60) Provisional application No. 63/566,997, filed on Mar. 19, 2024.

(51) Int. Cl. G06Q 40/06; G06Q 10/04

(52) U.S. Cl. CPC G06Q 40/06; G06Q 10/04

(57) ABSTRACT

A method for improving the accuracy of forecasts for the performance data for a private equity fund includes: (1) receiving a dataset for the historical performance data of each of a plurality of private equity funds, (2) separating this dataset into a plurality of subsets, with each subset having similar private equity funds with respect to their investment strategy and required characteristics for to-be-invested-in companies, (3) selecting the subset that has the private equity funds which are closest to those of the private equity fund for which a forecast is desired, (3) creating for this subset a machine learning training set by cleaning and normalizing its historical performance data, (4) applying a machine learning methodology to this training set to create a machine learning model for forecasting the desired future performance data, and (5) using this machine learning model to provide the desired, improved accuracy forecast.

### CROSS-REFERENCE TO RELATED APPLICATION

This application claims the benefit of Provisional Patent Application No. 63/566,997, filed Mar. 19, 2024 by the present inventors. The teachings of this application are incorporated herein by reference to the extent that they do not conflict with the teaching herein.

### BACKGROUND OF THE INVENTION

### 1. Field of the Invention

The present invention generally relates to data processing with respect to financial and business practices. More particularly, the present invention is directed to forecasting and improving the performance of a private investment (e.g., equity, debt) fund.

### 2. Description of the Related Art

A private investment partnership provides the opportunity for accredited investors (see 17 CFR § 230.501) and institutional investment firms to combine their long term, high dollar value investments or capital commitments for the purpose of having the partnership manage and invest these capital commitments via private funds which primarily buy equity or extend loans to private companies. Often, the amount of these private equity fund investments in private companies is sufficient to give the private equity firm some level of control of these companies. The private fund firm ideally uses this control to increase these companies' financial performances, business positions, total sales, and thereby their profitability to enhance the eventual return on their investors' capital commitments (or ROI, return on investments).

There are many types of private investment funds. These are usually distinguishable by the investment strategies of the private funds (e.g., venture capital, growth equity, leveraged buyouts, real estate, distressed debt) and the required characteristics of the selected companies in which the private fund looks to invest (e.g., the sector of the economy in which their selected companies operate, a selected company's geographic operating location, the age of the selected company, assessment of the ability of the management of a selected company, size of a selected company, historical performance of a selected company, degree of control obtained by making a specified investment in a selected company, size of the market held by a selected company).

The methods of operation of these funds are often similar and include: (a) an inception period in which a fund's investment goals are identified and the general partner(s) market the fund to obtain the limited partners' capital commitments to fund its planned investments, (b) an investment period (typically year's 1-4 since the fund's inception or inception year) during which the investors capital commitments are called i.e., “capital calls” are invested and improvements are made to the invested-in companies or companies to increase their value, and (c) a harvest period (typically year's 5-12) in which the companies are sold (thereby decreasing the market value of the remaining equity in the fund, or the fund's net asset value (NAV)) and the profits from these sales are distributed as “distributions” among the investors (i.e., limited partners) based on how much they contributed to the fund and after the private investment management firm (i.e., the general partner) has taken its fee.

FIG. 1 presents these periods and shows, over an assumed, fifteen year life of a typical private investment fund its characterizing performance data. This includes a fund's representative demands for cash input (cumulative capital calls), net asset value (NAV) or the market value of the remaining equity in the fund, and its cumulative distributions to the investors as a result of the proceeds (Co.'s sales price—purchase price—expenses) from the fund's sale of the equity or debt in which it has taken positions. These quantities are shown in FIG. 1 as a percentage of the fund's capital commitment to fund its planned investments. Capital is called during the investment period which increases the NAV of the fund. In later stages, the profits from the asset sales are distributed to the investors. As one can see in this figure, after the investment period, the distributions become larger than the called capital (assuming the proceeds are larger than the original invested amount) and the NAV decreases. A private investment fund generates cash as the positions or equity in the companies it holds are liquidated.

Compared with other types of investments that can be easily converted into cash (e.g., listed stocks) private investment funds' comparatively long investment periods result in them being classified as a type of illiquid asset. However, unlike other illiquid assets, private funds are, as shown in FIG. 1, a distributing asset since they generate liquidity when the underlying investments (or the private companies in which a fund has equity) are subsequently sold; thus resulting in the fund distributing proceeds from realized asset sales. Since a fund's NAV is transformed into cash without requiring any action from the investor; private investment funds can be considered to have a self-liquidating characteristic.

As a private fund ages and its investments increase in value, it eventually reaches a point in time when its cumulative distributions exceed its cumulative capital calls. However, it may take some time to reach this state.

Therefore, prudent investors are always looking for tools that will help them better forecast the performance data or economic performance of their private fund investments (e.g., a risk management tool that allows the investor to quantify the liquidity requirements of a private equity fund-a means for forecasting the cash flow of a fund). This effort is aided by the existence of large databases, including time series datasets, of the historical financial data and records that exist for a wide range of financial products, including private companies and private investment funds. Using historical financial data, many prior attempts have been made to forecast the performance of a wide range of financial products based on the development of various sophisticated forecasting models/systems, including those developed by using assorted machine learning techniques. A review of these as it relates to forecasting stock market performance can be found at “Machine learning techniques and data for stock market forecasting: A literature review,” Mahinda M. Kumbure, Christoph Lohrmann, Pasi Luukka, and Jari Porras; Expert Systems with Applications, Vol. 197, 1 Jul. 2022; Elsevier B.V.; see https://www.sciencedirect.com/science/article/pii/S0957417422001452.

Additionally, there exist within the patent literature the disclosure of various tools for forecasting the performance of a private equity fund. See U.S. Pat. Nos. 7,698,196 and 8,386,356.

Despite this prior art, the dependability of the forecasts for the performance of a private equity fund is often not as accurate as one would like. Therefore, there continues to be a need for improved means and methods for forecasting the 17 financial performance of private equity investments. With a tool for better quantifying the liquidity requirements of a private equity fund, it is hope that the actual economic performance of such funds can be improved.

### BRIEF DESCRIPTION OF THE DRAWINGS

FIG. 1 shows for a typical private equity fund its representative demands for cash input (cumulative capital calls), net asset value (NAV), and its cumulative distributions (with each normalized the fund's capital commitment) to the fund's investors as a result of the assumed proceeds the fund has realized from the sale of the companies in which it has taken equity positions.

FIGS. 2-4 present the various elements or steps in a flow diagram of the present invention's ensemble-based, machine learning model for forecasting the performance data or the future market values, distributions, and capital call amounts for a private equity fund in which an investor has made a capital commitment.

FIGS. 5 and 6 show a listing on the respective input and output variables used by the present invention.

FIG. 7 illustrates the form that the historical output data for the present invention takes after its input data and its timelines have been appropriately scaled.

FIG. 7A provides an example of the parts of the programming code of the present invention that achieves the step listed in FIG. 4 as “Create training data array with every possible combination of present and future: . . . .”

FIG. 7B provides an example of the parts of the programming code of the present invention that achieves the step listed in FIG. 4 as “Train Models: Market Value Model, Contribution Value Model and Distribution Value Model.”

FIG. 7C provides an example of the parts of the programming code of the present invention that are associated with predicting desired output variables and achieving the step listed in FIG. 4 as “Loop through each time period and target prediction time period.”

FIGS. 8-10 provide examples which illustrate the accuracy of the prediction results for the present invention for the following parameters of interest: called/committed capital (CC), distributions/committed capital (DC) and net or residual market value/committed capital (RVC).

FIG. 11 illustrates how the model or method of the present invention is expected to be used in the workplace of a financial services entity by a financial or wealth advisor.

FIG. 12 provides an example of the screen shot that one, who is using the present invention, might encounter in inputting into the model the necessary information for predicting the future financial performance of a privity equity fund.

FIG. 13 provides an example of the screen shot that one, who is using the present invention, might encounter when receiving the present invention's output of predicted or forecasted ratios for market value/committed, called/committed, and distributed/committed on a quarterly basis as a ratio or percentage of capital committed to for the private investment fund whose input data is shown in FIG. 12.

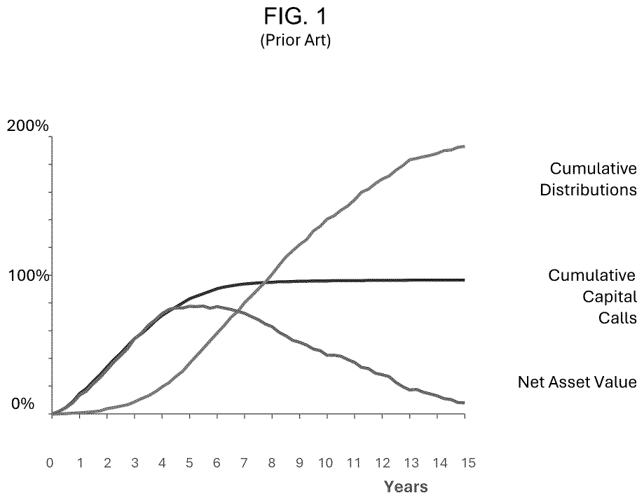

### DESCRIPTION OF THE PREFERRED EMBODIMENT

Recognizing the need for improved means and methods for forecasting the performance of private investment funds, the present invention seeks to use novel, machine learning techniques to provide such tools.

Various aspects, advantages, features and embodiments are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The below invention disclosure assumes a basic understanding of data science and machine learning methodologies, including the knowledge of a programming language that would enable one to build computer applications that utilize “supervised learning” ensemble techniques for regression prediction (i.e., those that predict a continuous output variable from given input data or variables). Examples of such regression algorithms include: Linear Regression, Decision Tree, Random Forest and Gradient Boosting (GBM, XGBoost, LightGBM and CatBoost).

The present invention's desired objective of an improved method or means for forecasting the performance of private funds is aided by the fact that there is a large database or dataset (made available to the public by, for example, Preqin Ltd) of the financial data and records (e.g., the quarterly fiscal results of a private equity fund's market values, distributions and called capital amounts) of an extensive number of past and current private funds. Additionally, there is sufficient other information about these funds so that they can be characterized in terms of a set of investment strategies (e.g., venture capital, growth equity, leveraged buyouts) and required characteristics for the companies in which the various funds will invest.

The present invention employs a novel, ensemble-based, machine learning methodology to construct an assumption-free, machine learning model to forecast the future market values, distributions, and capital call amounts for private equity funds. The result is improved financial forecasting for one's investments or holdings in private equity funds.

Rather than apply a machine learning methodology to all the available historical performance data for private equity funds, the present invention selects for its algorithm creating process only those private equity funds that have the same investment strategy and required company characteristics as that of the private equity fund for which the forecast is desired (i.e., the utilized private equity fund).

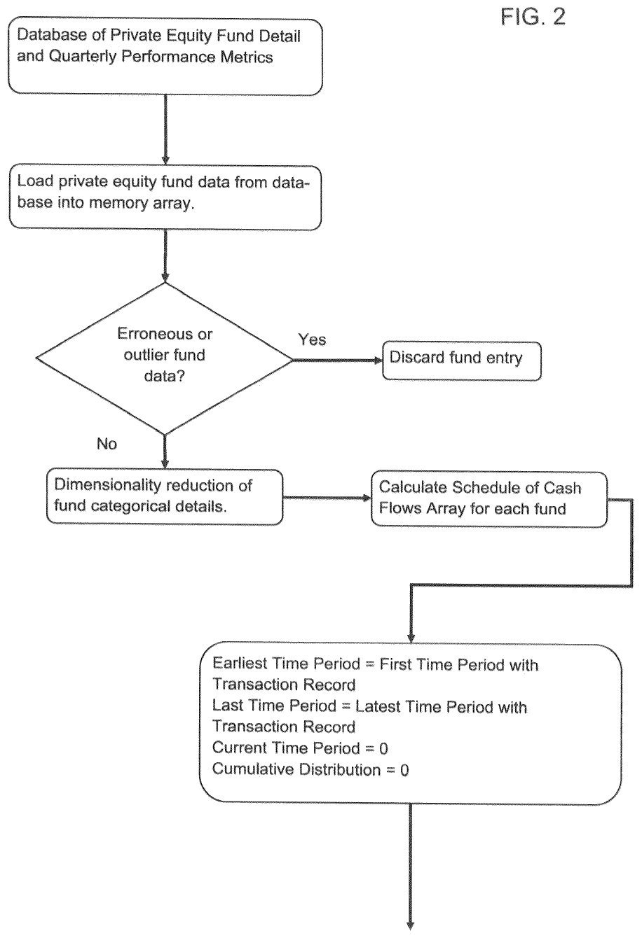

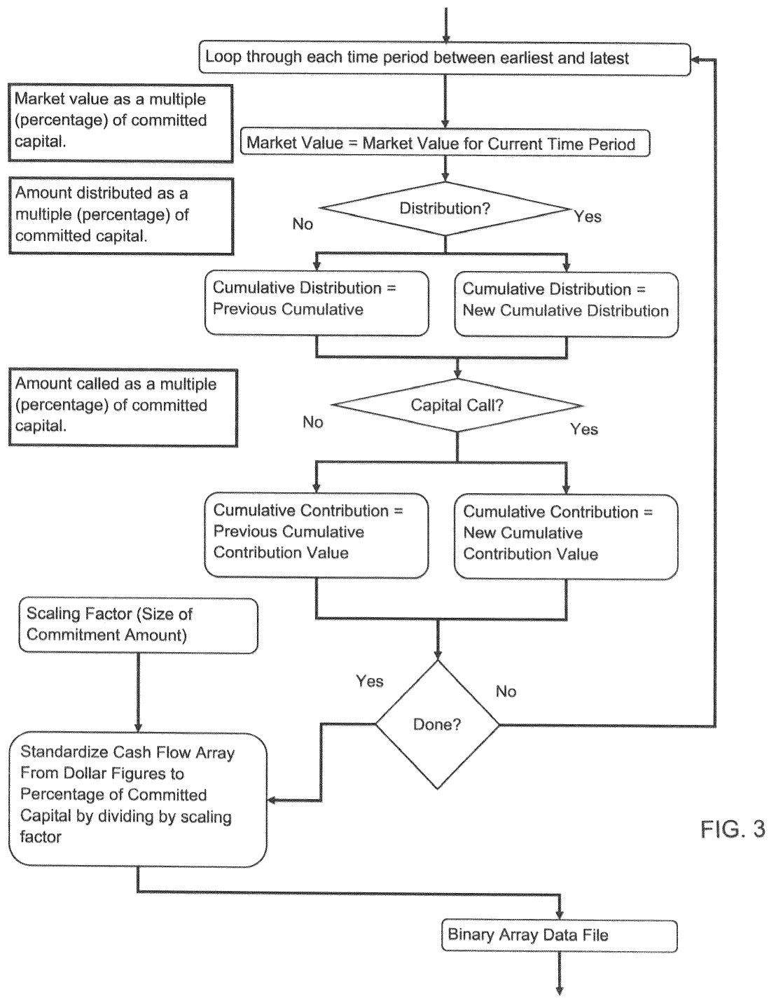

FIGS. 2-4 present the various elements or steps in a flow diagram of the present invention's ensemble-based, machine learning model for forecasting the future market values, distributions, and capital call amounts for a private equity fund in which an investor has made or is considering making a capital commitment.

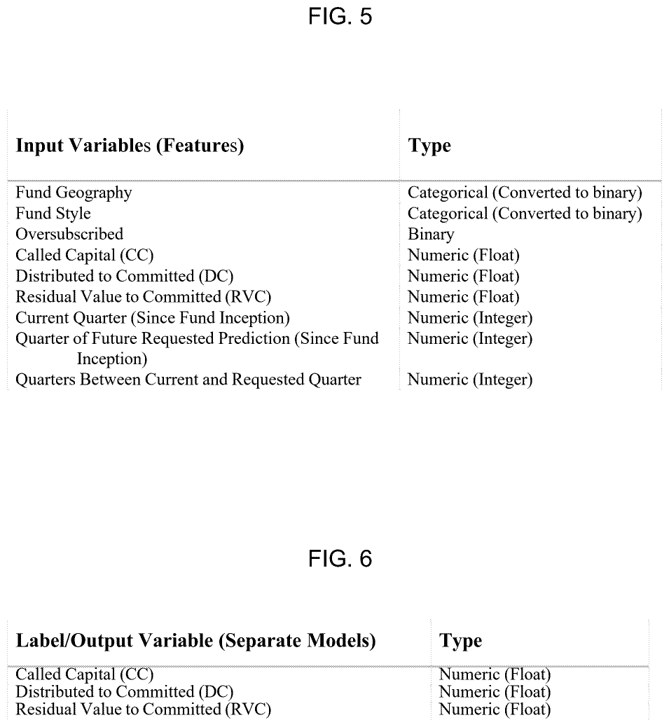

The operation of the model starts with choosing time-series data (i.e., the individual quarterly fiscal results {which we express as the output variables of market or residual values (RV), distributions (D) and called capital (CC) amounts} of a plurality of private funds that share the same investment strategy and required company characteristics. This data is then pre-processed to discard outliers in the data and then further pre-processed to dimensionally reduce and normalize it so that the different fiscal results can be directly compared in terms of percentages rather than dollar amounts. We use the investor's dollar capital commitment amount as a scaling factor to perform this normalization. FIGS. 5 and 6 show a listing on the respective input and output variables used by the present invention.

The time scales for these fiscal results are similarly scaled or normalized to enable the results from different time periods to be compared. This is accomplished by using a time scale that is not expressed in terms of dates, but by converting a specific fiscal result date to the number of the quarter the date represents since a fund's inception.

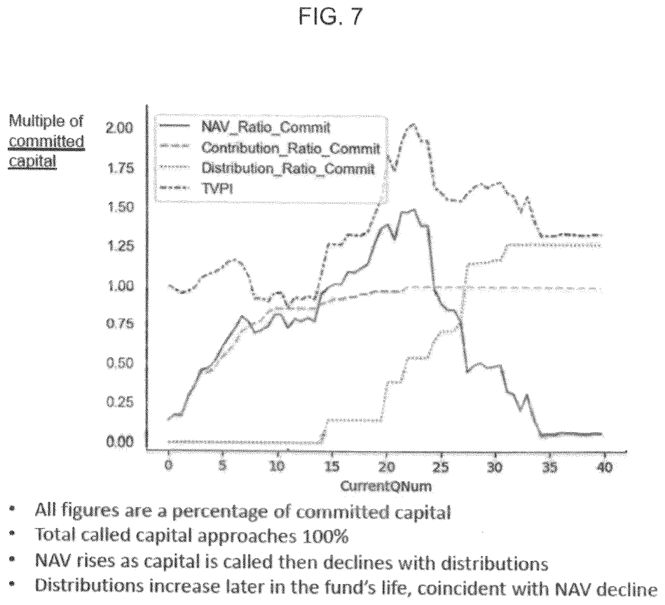

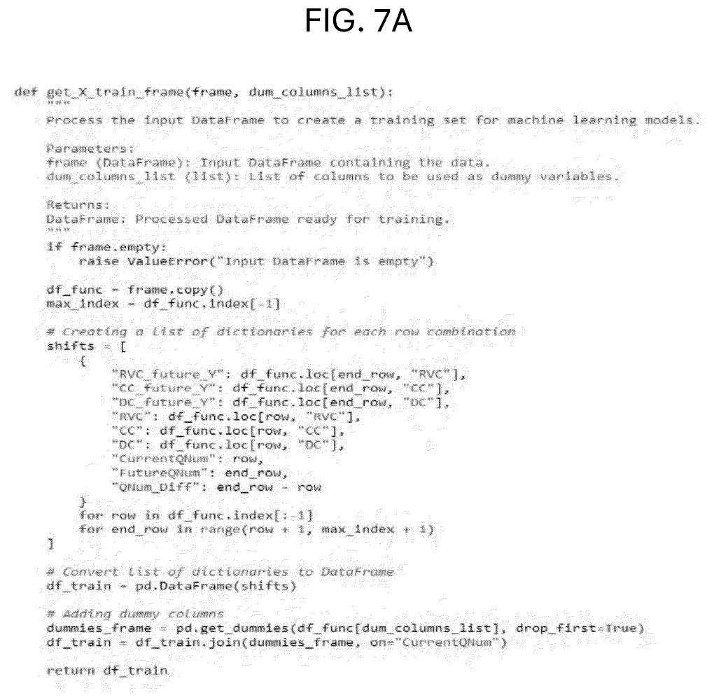

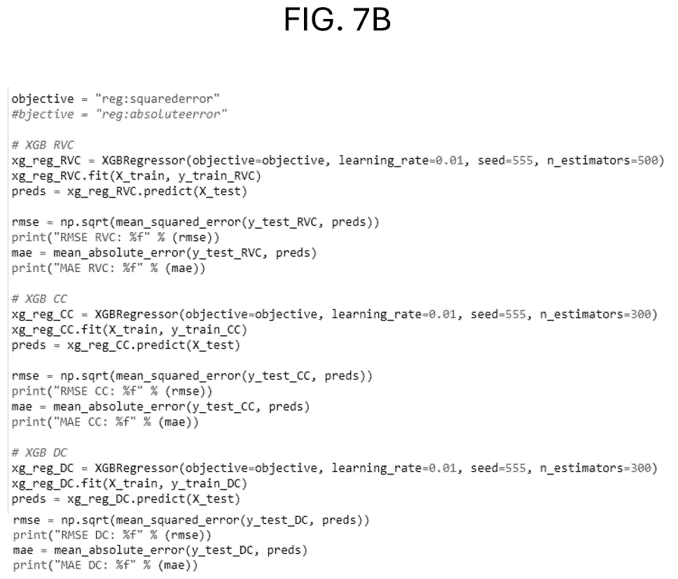

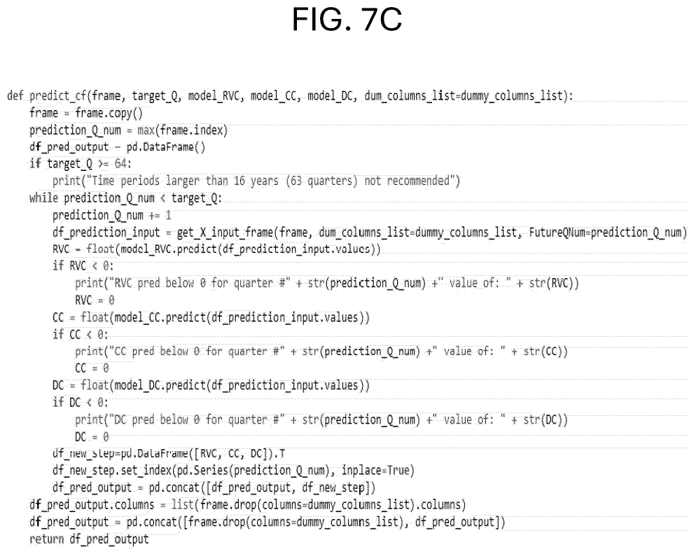

Once the historical input and output data for the various private funds are properly scaled, for each fund in our sample, its data is put into a form that can be used to train our ensemble-based, machine learning model. An example of these output results is shown in FIG. 7 where the model's desired output variables are mapped as a function of time (i.e., expressed as a temporal date expressed as the number of the quarter the date represents since a fund's inception).

The historical data of the present invention was segregated into training and testing datasets based on the inception year of the individual private investment funds. This utilization of an inception year as a discriminative factor serves to prevent lookahead bias. This strategy facilitates the training of our model on a subset of earlier funds, and subsequently testing it on later inception years that have different economic and market conditions.

After much experimentation with various regression algorithms (i.e., random forest (scikit-learn), regularizing gradient boosting ensemble method (XGBoost), and deep artificial neural networks (TensorFlow, Keras)), it was decided that, in order to provide sufficient accuracy and stability in the present invention's prediction results, the model of the present invention would use a machine learning technique that employs a Gradient Boosting or GBM ensemble machine learning algorithm.

This algorithm was used to train three separate models, each of which predicts one of the present invention's three, main output variables or metrics of interest (i.e., on a quarterly basis, called contribution in the form of future called/committed (CC), distributions in the form of future distributed/committed (DC) and net market value amounts in the form of future residual value/committed (RVC)). Hyperparameter tuning was performed using a grid search approach to locate optimal model parameters.

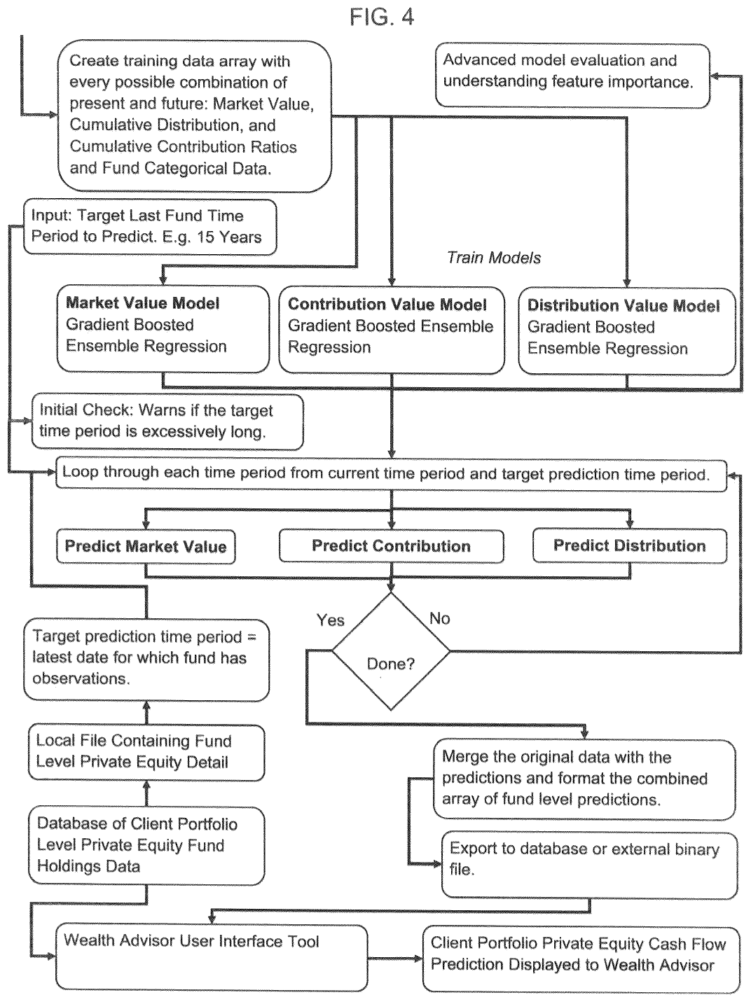

To more fully explain how the present invention achieves these training processes, see FIG. 4 that lists the key elements or steps in the present invention's training processes. These included the steps of “Create training data array with every possible combination of present and future: . . . ” and “Train Models: Market Value Model, Contribution Value Model and Distribution Value Model.” Examples of parts of the programming code used by the present invention to accomplish these steps are shown in FIGS. 7A and 7B.

As the present invention moves further towards the task of predicting its desired output variables, FIG. 4 lists the additional key step of “Loop through each time period and target prediction time period.” An example of parts of the programming code used by the present invention to accomplish this step is shown in FIG. 7C.

Each model includes the current value of all three metrics and the above specified metrics as input features. In doing so, the fund performance in terms of market value relative to committed multiple serves as an input into predicting future distributions, which is intuitive from a fundamental investment analysis perspective. There are additional statistical relationships between various input and predicted metrics, such as the tendency of funds which call capital sooner to deliver stronger performance later in the fund's life. By including all ratios as an input in the prediction of each single future ratio, the model incorporates these statistical relationships, as well as the interactions between variables which can interact in a nonlinear manner.

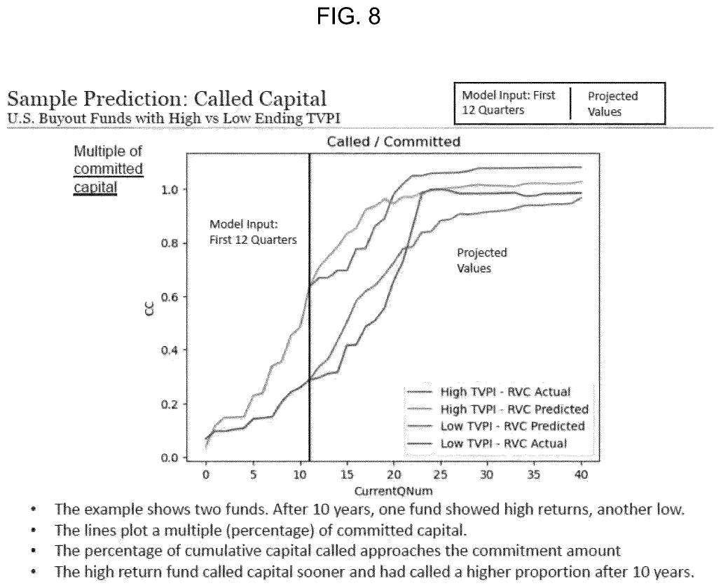

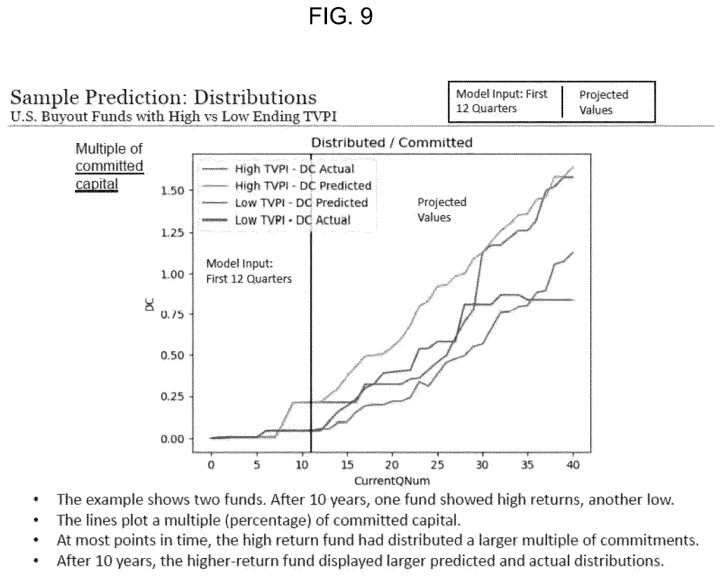

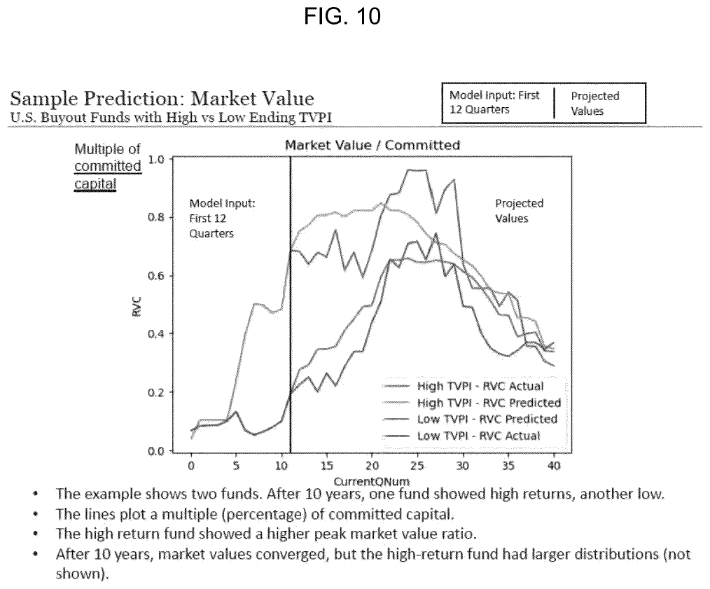

Examples of the accuracy of the prediction results for the present invention are shown in FIGS. 8-10 for our parameters of interest: called/committed capital (CC), distributions/committed capital (DC) and net or residual market value/committed capital (RVC). This level of accuracy was seen to be achievable for private equity funds having a wide range of fiscal results, including both high and low returns in terms of TVPI, Total Value to Paid-In. These results were achieved by providing the various prediction models used with input that included the value of the parameter of interest for the twelfth quarter of the fund's life and then using the models to predict this performance for quarters thirteen to forty and comparing this to the fund's actual results.

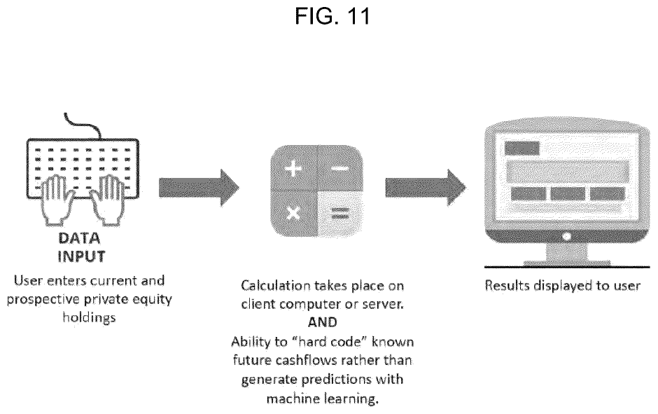

FIG. 11 illustrates how the model or method of the present invention is expected to be used in the workplace of a financial services entity by a financial or wealth advisor. When an entity's client, having various private fund investments, wants an estimate or forecast on a quarterly basis for the future net market values, distributions, and capital call amounts for the client's private fund holdings, the wealth advisor using the present invention can now provide this desired information with more prediction accuracy than prior forecasting models. The present invention can also be used to compare the actual, past performance of a private equity fund with that which the present invention forecasts for the fund.

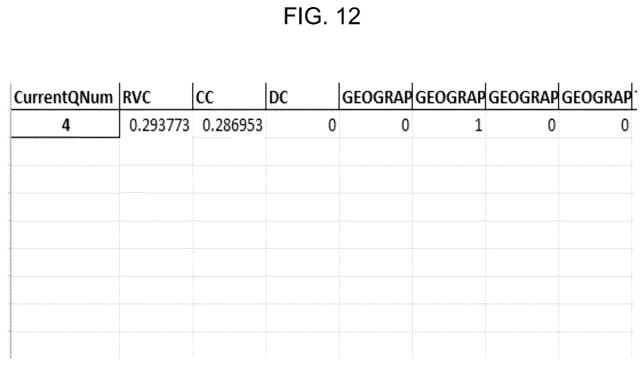

FIG. 12 provides an example of the screen shot that one, who is using the present invention, might encounter in inputting into the model some of the necessary information for predicting the future financial performance of a privity investment fund. This information includes the current quarter number of the fund (“CurrentQNum”), quarters since inception), and ratios for market value/committed capital, “RVC”, called/committed capital, “CC,” and distributed/committed capital, “DC,” as well as the geography and fund style categories transformed into binary indicator variables.

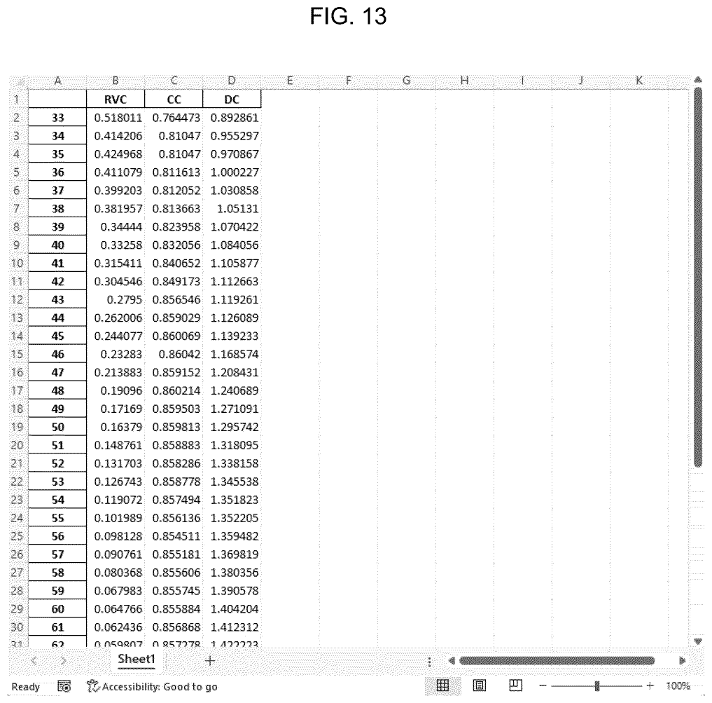

FIG. 13 provides an example of the screen shot that one, who is using the present invention, might encounter when receiving the present invention's output of predicted or forecasted ratios for market value/committed capital, “RVC”, called/committed capital, “CC,” and distributed/committed capital, “DC,” on a quarterly basis for the private equity fund whose input data is shown in FIG. 12.

The foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention as set forth in the following claims to the invention.

We claim:

1. A method for improving the accuracy of the forecasting for the performance data for a utilized private equity fund having an investment strategy and required characteristics for the private companies in which said utilized private equity fund invests, and to which an investor has made a capital commitment, said method comprising the steps of:
receiving, by a computing system, a dataset for the historical performance data of each of a plurality of private equity funds, each of which has an investment strategy and required characteristics for the private companies in which said private equity fund invests,
separating said dataset into a plurality of subsets of historical performance data and wherein each subset has the historical performance data for those similar private equity funds that share the same investment strategy and required characteristics for the private companies in which said plurality of similar private equity funds invest,
selecting from said plurality of subsets of historical performance data the subset that has the same investment strategy and required characteristics for said private companies as that of said utilized private equity fund,
creating, in said computing system, for said selected subset a selected machine learning training set by cleaning and normalizing said historical performance data for each of said plurality of similar private equity funds in said subset,
applying a machine learning methodology to said selected, machine learning training set to create a machine learning model for forecasting the future performance data for said utilized private equity fund, and
using said machine learning model to provide an improved forecast for the performance data for said utilized private equity fund.

2. The method recited in claim 1, wherein:
said performance data for said utilized private equity fund including the quarterly fiscal results for a market value, distribution and called capital amount.

3. The method recited in claim 1, wherein:
said required characteristic, for a selected private company in which said utilized private equity fund invests, is chosen from the group consisting of: the sector of the economy, geographic operating location, age, assessment of the ability of management, size, historical performance, degree of control obtained by making a specified investment, and size of the market held.

4. The method recited in claim 2, wherein:
said required characteristic, for a selected private company in which said utilized private equity fund invests, is chosen from the group consisting of: the sector of the economy, geographic operating location, age, assessment of the ability of management, size, historical performance, degree of control obtained by making a specified investment, and size of the market held.

5. The method recited in claim 1, wherein:
said machine learning methodology uses an ensemble machine learning technique.

6. The method recited in claim 2, wherein:
said machine learning methodology uses an ensemble machine learning technique.

7. The method recited in claim 3, wherein:
said machine learning methodology uses an ensemble machine learning technique.

8. A non-transitory, computer readable medium having program code recorded thereon, for execution on a computing system having a display, to improve the accuracy of the forecasting for the performance data for a utilized private equity fund having an investment strategy and required characteristics for the private companies in which said utilized private equity fund invests, and to which an investor has made a capital commitment, said program code causing said computing system to perform the following steps:
receiving a dataset for the historical performance data of each of a plurality of private equity funds, each of which has an investment strategy and required characteristics for the private companies in which said private equity fund invests,
separating said dataset into a plurality of subsets of historical performance data and wherein each subset has the historical performance data for those similar private equity funds that share the same investment strategy and required characteristics for the private companies in which said plurality of similar private equity funds invest,
selecting from said plurality of subsets of historical performance data the subset that has the same investment strategy and required characteristics for said private companies as that of said utilized private equity fund,
creating, in said computing system, for said selected subset a selected machine learning training set by cleaning and normalizing said historical performance data for each of said plurality of similar private equity funds in said subset,
applying a machine learning methodology to said selected, machine learning training set to create a machine learning model for forecasting the future performance data for said utilized private equity fund, and
using said machine learning model to provide an improved forecast for the performance data for said utilized private equity fund.

9. The non-transitory, computer readable medium as recited in claim 8, wherein:
said performance data for said utilized private equity fund including the quarterly fiscal results for a market value, distribution and called capital amount.

10. The non-transitory, computer readable medium as recited in claim 8, wherein:
said required characteristic, for a selected private company in which said utilized private equity fund invests, is chosen from the group consisting of: the sector of the economy, geographic operating location, age, assessment of the ability of management, size, historical performance, degree of control obtained by making a 28 specified investment, and size of the market held.

11. The non-transitory, computer readable medium as recited in claim 9, wherein:
said required characteristic, for a selected private company in which said utilized private equity fund invests, is chosen from the group consisting of: the sector of the economy, geographic operating location, age, assessment of the ability of management, size, historical performance, degree of control obtained by making a specified investment, and size of the market held.

12. The non-transitory, computer readable medium as recited in claim 8, wherein:
said machine learning methodology uses an ensemble machine learning technique.

13. The non-transitory, computer readable medium as recited in claim 9, wherein:
said machine learning methodology uses an ensemble machine learning technique.

14. The non-transitory, computer readable medium as recited in claim 10, wherein:
said machine learning methodology uses an ensemble machine learning technique.

15. A computer system having a processor and a user interface operatively connected to the processor, and used for improving the accuracy of the forecasting for the performance data for a utilized private equity fund having an investment strategy and required characteristics for the private companies in which said utilized private equity fund invests, and to which an investor has made a capital commitment, said computer system comprising:
a dataset for the historical performance data of each of a plurality of private equity funds, each of which has an investment strategy and required characteristics for the private companies in which said private equity fund invests,
said processor configured to separate said dataset into a plurality of subsets of historical performance data and wherein each subset has the historical performance data for those similar private equity funds that share the same investment strategy and required characteristics for the private companies in which said plurality of similar private equity funds invest,
said processor configured to select from said plurality of subsets of historical performance data the subset that has the same investment strategy and required characteristics for said private companies as that of said utilized private equity fund,
said processor configured to create for said selected subset a selected machine learning training set by cleaning and normalizing said historical performance data for each of said plurality of similar private equity funds in said subset,
said processor configured to apply a machine learning methodology to said selected, machine learning training set to create a machine learning model for forecasting the future performance data for said utilized private equity fund,
said processor configured to use said machine learning model to provide an improved forecast for the performance data for said utilized private equity fund, and
said user interface configured to. display said improved forecast for the performance data for said utilized private equity fund.

16. The computer system as recited in claim 15, wherein:
said performance data for said utilized private equity fund including the quarterly fiscal results for a market value, distribution and called capital amount.

17. The computer system as recited in claim 15, wherein:
said required characteristic, for a selected private company in which said utilized private equity fund invests, is chosen from the group consisting of: the sector of the economy, geographic operating location, age, assessment of the ability of management, size, historical performance, degree of control obtained by making a specified investment, and size of the market held.

18. The computer system as recited in claim 16, wherein:
said required characteristic, for a selected private company in which said utilized private equity fund invests, is chosen from the group consisting of: the sector of the economy, geographic operating location, age, assessment of the ability of management, size, historical performance, degree of control obtained by making a specified investment, and size of the market held.

19. The computer system as recited in claim 15, wherein:
said machine learning methodology uses an ensemble machine learning technique.

20. The computer system as recited in claim 16, wherein:
said machine learning methodology uses an ensemble machine learning technique.
